(19) United States
(12) Patent Application Publication
(10) Pub. No.: US 2012/0096883 A1
(43) Pub. Date: Apr. 26, 2012

(54) Climate Simulation System with Cold Accumulation Technique

(76) Inventor: Hamdi Tavsan, Ankara (TR)

(21) Appl. No.: 13/382,152

(22) PCT Filed: Jun. 28, 2010
(86) PCT No.: PCT/TR2010/000122

§ 371 Date: Jan. 3, 2012

(30) Foreign Application Priority Data
Jul. 6, 2009 (TR) 2009/05249

(51) Int. Cl. F25D 17/02; H01M 10/42; F24F 3/12; G05D 23/30

(52) U.S. Cl. 62/185; 62/176.1; 62/157; 429/90; 165/222; 165/227; 165/287

(57) ABSTRACT

This invention is about a climate simulation system (10) which provides with minimum energy consumption, the growth under preferred climate conditions and monitoring of living species such as plant, bacteria and insects in research laboratories, which minimizes the temperature fluctuation within the air-conditioning chamber and which provides the cooling of air-conditioning chamber (20) by use of cold accumulation.

### TECHNICAL AREA

This invention is related to a system that simulates the climate using cold accumulation, enabling the observation and growth of plants, bacteria, and creatures such as insects, at the preferred climate conditions.

### PREVIOUS TECHNOLOGY

Nowadays there are ongoing studies on many subjects; such as resolving agricultural issues in regions with different climates and ecologies, diseases that restrict herbal production, protecting plants against harmful weeds, determining and preventing elements that restrict production, increasing agricultural production, increasing quality, increasing new production unique to different regions, increasing quality, and developing new production methods and seeds unique to different regions. Data obtained from these studies are tested on plants and successful data is applied to cultivation areas.

Data obtained from research is applied to plants and the results are observed. Research is carried out in regions with different climates and ecologies. Research results are applied and observed under the climate and ecology for the region of the related plant type. There are rooms in research laboratories where the different regional climate conditions can be simulated. Researchers observe their researches and research results in these climate rooms. The climate rooms must be sensitive enough to enable the climate conditions for the region, in which the application will be carried out. The climate rooms must remain stabilized for the duration, at the temperature, and humidity chosen by the user.

Today, there are various air conditioning simulation rooms which provide that the experiments on the livings such as plant, insect, bacteria be carried out in the preferred climate conditions. In the climate simulation systems, there are air conditioning room, light, heaters, cooler, moisturizer, and compressor. The most important feature required for climate simulation rooms is that there exists the least waving or deviance (at a rate that it can not damage the plant, insect, etc.) in the preferred temperature and the humidity levels. It is very important for accuracy of the experiment and for the health of the living that the temperature and the humidity stays fixed. In some part of the current applications, the compressor works always in order that the temperature is fixed at the desired level. In this application, there exist valves at the input and output of the compressor; when the room is needed to be cooled, this valve is turned off, and the cooling begins. When the necessary cooling is gained, the valve is turned on, the compressor short-circuits, and the cooling stops. With this application, control is performed at a definite sensitivity level. However, as the valve is turned on and off many times in this application, a periodical renewal is required, and much energy consumption is very high as the compressor works much. In the current other applications, the compressor doesn't always work. In these kinds of applications, when the preferred temperature level is over, the compressor becomes active, and it works until the temperature reaches at the desired set value. The disadvantage of this application is that the oscillation is very high. Since the leaf surface, especially, of the plants is big, and the mass is little, the temperature change is sensed fast by the plant. This condition puts stress on the subject. The environment where the temperature increases and decreses periodically damages especially the plants. This temperature difference causes the plants die or damaged.

The air conditioning rooms shall work with the minimum deviance at the preferred temperature and the humidity level in order to get the right results from the experiments. A real research environment and the right results can only be achieved under only these conditions.

Today, there are various air conditionig simulation rooms which provide that the experiments on the livings such as plant, insect, bacteria be carried out in the preferred climate conditions. In the climate simulation systems, there are air conditioning room, light, heater, cooler, moisturizer, and compressor. The most important feature required for climate simulation rooms is that there exists the least waving or deviance (at a rate that it can not damage the plant, insect, etc.) in the preferred temperature and the humidity levels. It is very important for accuracy of the experiment and for the health of the living that the temperature and the humidity stays fixed. In some part of the current applications, the compressor works always in order that the temperature is fixed at the desired level. In this application, there exist valves at the input and output of the compressor; when the room is needed to be cooled, this valve is turned off, and the cooling begins. When the necessary cooling is gained, the valve is turned on, the compressor short-circuits, and the cooling stops. With this application, control is performed at a definite sensitivity level. However, as the valve is turned on and off many times in this application, a periodical renewal is required, and much energy consumption is very high as the compressor works much. In the current other applications, the compressor doesn't always work. In these kind of applications, when the preferred temperature level is over, the compressor becomes active, and it works until the temperature reaches at the desired set value. The disadvantage of this application is that the oscillation is very high. Since the leaf surface, especially, of the plants is big, and the mass is little, the temperature change is sensed fast by the plant. This condition puts stress on the subject. The environment where the temperature increases and decreases periodically damages especially the plants. This temperature difference causes the plants die or damaged.

The air conditioning rooms shall work with the minimum deviance at the preferred temperature and the humidity level in order to get the right results from the experiments. A real research environment and the right results can only be achieved under only these conditions.

A climate control cabin of which temperature and humidity rates could be controlled is mentioned in Germany patent license numbered DE198117372 which is available in technique's known condition.

### SHORT DESCRIPTION OF THE INVENTION

The objective of this invention is to perform climate simulation system with cold accumulation that provides the preferred climate conditions and minimum temperature/humidity oscillation and minimum energy consumption.

### DETAILED DESCRIPTION OF THE INVENTION

Cold accumulation and climate simulation systems that have been applied in order to reach the objective of this invention are shown in attached figures as follows:

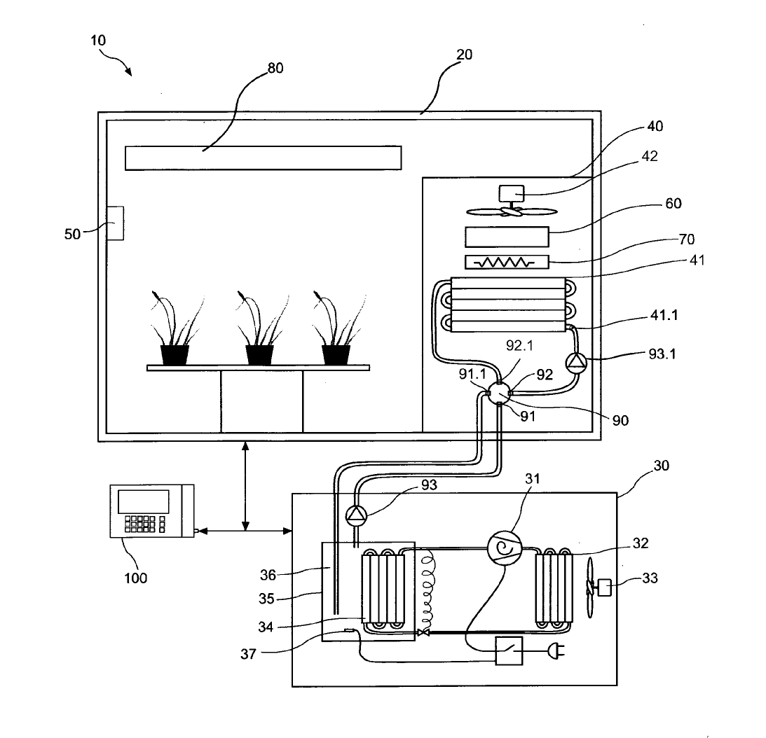

FIG. 1—It is schematic image of the climate simulation system.

Parts of the figures have been individually numbered and their equivalents are given below.
10. Climate simulation system
20. Air-conditioning room (heat insulated room)
30. External Unit (Chiller-group)
31. Compressor
32. Condenser
   33 Condenser fan
   34 Evaporator
   35 Cooling fluid tank (accumulator)
   36 cooling fluid
   37 Temperature probe
40. Internal Unit
41. Battery
41.1. Temperature sensor
42. Fan
50. Cab internal sensor
   60. Humidifier
   70. Heater
   80. Illumination
   90. Four-way mixer valve
   91. Accumulator outlet (Inlet)
   91.1. Accumulator—turn
   92. Battery input (output)
   92.1. Battery Output
   93. Accumulator recirculation pump
   100. Control Unit

The climate simulation system basically includes:
At least one air-conditioning room where the preferred climate conditions are provided (20),
At least one external unit that enables the required cooling for air-conditioning room (20) (30),
At least one internal unit (40) that enables heating, cooling, humidifying and dehumidification in air-conditioning room (20),
At least one cab internal sensor (40) measuring temperature and humidity rate of the air-conditioning room (20),
At least one humidifier (60) that provides necessary humidity for air-conditioning room (20),
At least one heater that provides necessary heat for the air-conditioning room (20),
At least one illumination that provides necessary illumination for the air-conditioning room (20),
At least 3 or 4 way mixer valves (90) that provides proportional flow of the necessary cooling fluid for the air-conditioning room (20), and
At least one control unit (100) that provides operation of the air-conditioning room (20) in a preferred temperature and humidity by controlling its temperature and humidity rate.
It includes at least one control unit (100) which provides the air conditioning room work on the preferred temperature and humidity level by controlling the temperature and humidity level of the air conditioning room (20).

In the subject invention climate simulation system (10), the livings such as plant, insect, bacteria, are kept in the air conditioning room (20). The user (researcher) determines the temperature and humidity value of the air conditioning room (20) for that it works in accordance with the claim of the experiment. These values are entered into the control unit (100). The user can enter the working conditions (humidity, temperature, light intensity and duration) of the air conditioning (20), and also can select one of the receipts in the control unit (100). The user starts the climate simulation system (10) after determining the working conditions.

In the subject invention climate simulation system (10), cooling process is provided by the outer unit (Chiller group) (30). The outer unit (30) includes compressor (31), condenser (32), condenser fan (33), evaporator (34), cooling liquid tank (35), cooling liquid (36), and the temperature probe (37). The outer unit (30) makes the cooler liquid (36) in the liquid tank (35) be cooled. The temperature of the cooling liquid is always checked by the temperature probe in the liquid tank. According to the working temperature of the air conditioning room (30), the cooling liquid (36) shall be at a definite temperature level. When the temperature of the cooling liquid (36) increases the preferred temperature, the compressor (31) starts. With its starting, the system is given pressure. With this pressure, the gas in the condenser (32) becomes liquid by changing phase. The condenser fan (33) makes the condenser (32) be cooled. The liquefied gas from the condenser (32) goes to the evaporator (34). The liquid entering into the evaporator (34) becomes gas here by evaporating, and during this process, the cooling is achieved. The evaporator is in cooling liquid accumulator tank (36). To have the evaporator cold, (34) makes directly the cooling liquid (36) got cold. Thus, with the working of the compressor (31), the cooling liquid (36) is cooled. With the accumulator circulating pump (93) at the output of the liquid accumulator tank (35), the cooling liquid (36) is pumped from the accumulator (35) into the mixer valve (90). Therefore, there exists a battery circulation pump (93.1) at the battery input of the four-way valve (92). This pump (93.1) makes the circulation in the cooling battery (41), and so, a homogenise temperature distribution is provided. In an alternative application of the invention, when a three-way mixer is used instead of a four-way valve (90), the battery circulation pump (93.1) is preferably not be used. While the three-way valve is reduced, the output flow decreases to zero, when the four-way valve (90) is used, the output flow is fixed.

In the subject invention climate simulation system (10), since the temperature of the liquid (36) in the cooling liquid tank (accumulator) (35) is kept cold, even in case of an instant cool down, the desired temperature is provided without a need for a powerful compressor (31).

The reason why the air conditioning room (20) is cooled is the temperature increase in the room (20) due to the lighting. In the subject invention climate simulation system (10), the outer unit (30) cools the cooling liquid (36), and on the other hand, the inner unit (40) cools the air conditioning room (20). The inner unit (40) includes the battery (41) and the fan (42). The cooling liquid (36) is circulated through the battery (41) in the inner unit (40). The cooling liquid (36) passing through the battery (41) cools the environment. The fan (42) transfers the cool air from the battery (41) to the air conditioning room (20). With the heat sensor (41.1) on the battery (41), the temperature of the cooling liquid (36) is measured. The heat sensor (41.1) always transmits the temperature value of the cooling liquid (36) to the control unit (100). The temperature of the air conditioning room (20) is controlled according to the in-cabin sensor (50) and the heat sensor (41.1). A sensitive control is provided thanks to that the air conditioning room (10) is controlled according to the temperature value of the cooling liquid (36) in the battery (41).

There are the inner unit (40), in-cabin sensor (50), humidifiers (60) and heater (70) in the air conditioning room (20). The in-cabin sensor (50) measures the temperature and the humidity level of the air conditioning room (20). There exist heat and humidity sensors which can make sensitive measurement in the in-cabin sensor (50).

Sensor (50) continually measures temperature and humidity rates of the air-conditioning room and transfers these values to the control unit (100). In case the temperature and humidity values of the air conditioning room (20) are different from the preferred values, the heater (70), the humidifier (60) and the mixer valve step in.

When the heater (70), the humidifier (60) and the valve are on, the air-conditioning room (20) reaches to the preferred temperature and humidity rate.

Cooling of the air-conditioning room (20) in the mentioned climate simulation system (10) is performed through four-way valve (90).

In alternative applications of the invention, three-way valve or dosing pump could be used instead of four-way valve. Mixer valve (90) has at least three ways. Four-way valve (90) has at least two inlets and two outlets.

These inlets and outlets (91,91.1, 92, and 92.1) could be proportionally controlled. Cooling fluid (36) is pushed from the cooling fluid tank (35) to the four-way valve (90) by accumulator recirculation pump (93).

Operation of the four-way valve (90) is controlled by the controlling unit (100). The four-way mixer valve (90) mixes the cool fluid (36) circulation at the side of the accumulator (35) into the fluid circulation at the side of the cooling battery (41). Flow rate in all inlets and outlets (91,91.1, 92, and 92.1) of the four-way valves (90) is the same. While, for instance, 20% of the 100 unit of fluid input in screw that is adjusted to 20% (twenty percent) proportion is transferred to the circulation of the battery input (92) and the battery (41); 80% returns to the accumulator (35) from the accumulator turning (91.1).

The left 20% battery comes from the circulation of the battery (41). The same is valid for the battery circulation (41). Mixer valve (90) adjusts the output temperature to the constant temperature even if heat of the cooling fluid (36) coming from the accumulator outlet (91) is released.

Since the heat of the cooling fluid (36) determined by the controlling unit (100) in order to provide temperature stability in the room (20) is highly constant, temperature fluctuation in the room (20) is almost non-existing.

In the mentioned climate simulation system (10), firstly, the required temperature and humidity values of the air-conditioning room are entered into the controlling unit (100) or they are selected from the controlling unit (100).

The control unit (100) constantly compares these preferred temperature and humidification values to the temperature and humidification values of the air-conditioning room (20). The control unit (100) runs the humidifier (60) when there is a decrease in humidification value of the air-conditioning room, and disables the humidifier (60) when the humidification value of the room has reached the preferred humidification value. In case of extreme humidification in the air-conditioning room (20), battery temperature is decreased to dew-point and dehumidification process is carried out while room temperature (20) is balanced with electric heater (70). The control unit enables the heater (70) when the temperature value of the air-conditioning room decreases below the preferred temperature and disables the heater (70) when the room temperature value reaches the preferred temperature value. Cooling of the air-conditioning room (20) is made by controlling the battery temperature found in external unit (30), mixer valve (90) and internal unit (40).

15. It is very important to keep the air-conditioning room constantly at the preferred temperature and humidification values. For example, when the user prefers the air-conditioning room (20) temperature as 20° C., the air-conditioning room (20) temperature must be 20° C. constantly. Ideally, our tolerance here should not go beyond 0.5° C. (+−). Otherwise, creatures will be harmed and the research will not be considered as healthy. Cooling of the air-conditioning room is very important. Cold accumulation is applied in the cooling of the air-conditioning room (20) in climate simulation invention system. In other words, the air-conditioning room (20) is cooled with the refrigerating liquid (36) in the refrigerating liquid tank (35). The compressor does not directly cool the battery (41), i.e. air-conditioning room (20) in the invention system. Thus, cold accumulation is applied in the said invention.

Cooling process can be considered in two parts in the climate simulation invention system (10). Cooling the refrigerating liquid (36) and cooling the air-conditioning room (20). Cooling of the refrigerating liquid (36) is made by compressor (31).

According to the temperature information (90) which the control unit (100) reads from the cab sensor, although the inputs and outputs of the valve (90) can be selected, the night/day selection can be done. Controlling unit (100) itself calculates the required temperature value of the cooling fluid (36) flowing to the battery (41). The temperature value of the cooling fluid (36) flowing to the battery (41), is continually measured by the temperature sensor (41.1) on the battery and conveyed to the controlling unit (100).

In alternative application of the invention; temperature sensor (41.1) is installed between the four-way valve (90) outlet and the recirculation pump (93.1). Controlling unit (100) controls the compressor (31) in terms of whether temperature value of the fluid (36) at the side of the accumulator (35) is the preferred teperature. Operation of the compressor (31) could be also performed by connecting a short circuit to the temperature probe (37) separately from the controlling unit (100).

When the temperature value of the cooling unit increases, the controlling unit (100) activates the compressor (31). Accordingly, gas into the condenser (32) becomes fluid by changing its phase. Condenser fan enables cooling of the condenser (32). Fluid released from the condenser (32) arrives to the EVAPORATOR (34). The fluid into the evaporator (34) vaporizes and this provides cooling of the evaporator (34).

Since the evaporator (34) is in the fluid tank (35), cooling fluid also cools together with the evaporator (34). Therefore, cooling fluid (36) into the cooling fluid tank (35) continually remains at the preferred temperature value. In the abovementioned climate simulation system (10), cooling fluid (36), air-conditioning room (20) and the temperature of this cooling fluid (36) continually remains at the preferred temperature value.

Controlling unit continually controls the temperature and humidity values of the air-conditioning room (20) through cab internal sensor (50). In case any increase in the temperature value occurs (when a change is seen in the preferred temperature value) that is, when the temperature value is beyond the preferred tolerance values, cooling process of the air-conditioning room (20) starts.

Controlling unit (100) firstly calculates the mixing rate of the valve (90). Then, it yields the calculated mixing rate of the valve (90). Recirculation pumps (93,93.1) pushes the cooling unit from the fluid tank (35) to the four-way valve (90) and subsequently to the battery (41). When the cooling fluid (36) enters into the battery (41) a change occurs in temperature value. The controlling unit (100) controls outlets and inlets (91,91.1,92,92.1) of the valve (90) according to the temperature data read on the cab internal sensor (50).

Circulation pumps (93,93.1) are preferably always on as the system is operating. The preferred temperature value is completely provided as the temperature value of the air-conditioning room (20) is adjusted by the valve (90). In case of minimum change in the preferred temperature, the air-conditioning room is interfered at preferred proportions by means of the valve (90). The control unit (100) controls the mixer valve (90) according to the temperature values coming from the cab sensor (50) and temperature sensor (41.1). In that case, the mixer valve (90) operates proportionally in accordance with the refrigerating liquid temperature within air-conditioning room (20) temperature and battery (41).

In the climate simulation invention system (10), as the interference to the temperature value of the air-conditioning room (20) is made by cold accumulation, the room (20) temperature value is set with refrigerating liquid (36) always at the same temperature value. Thus, the temperature variation of the air-conditioning room (20) is minimized.

The refrigerating liquid tank (35) used in the climate simulation invention system (10), is insulated. Thus, liquid tank (35) is affected by the external environment temperature at minimum level. Glycol is preferably used as the refrigerating liquid (36) in the simulation system. In alternative applications of the invention, equivalent liquids or coolers with different properties may be used as the refrigerating liquid (36).

In the invention system (10), the information such as temperature, humidification, operating status of the compressor and other engines are collected at the control unit (100). This information is transferred from the control unit (100) to the computer via data communication cards. Thus, the users can see the information relating to the climate simulation room (20) with the computer. Thanks to the ethernet card found on the control unit (100), the user has (internet) remote access to simulation system (10). The user connects the simulation system externally or follows the information relating to the air-conditioning room (20), possible warning or notifications by mobile telephone.

In the intervention simulation system (10), the cooling tank (35) can either be mounted in the external unit (30) or another place except the external unit (30). This situation does not affect the working status of the system (10).

In the intervention simulation system (10), there is at least one control unit (100). Preferably the control unit (100) is mounted out of the air conditioning room (20). In the alternative application of the invention, the control unit is mounted both inside the air conditioning room (20) and out of the room. Thus the user can see the temperature and humidity values inside the room (20). (The control system generally contacts by the valve, circuits and sensors performing the open/close transactions by RS-485 MOD Bus system). Thus additional sensors or similar units can be added to the system.)

The invention is not limited with the above mentioned applications and a technical expert can easily present different applications of the invention. These should be evaluated within the content of the protection requested together with the claims.

1.-18. (canceled)

19. A climate simulation system (10) with cold accumulation comprising:
at least one air-conditioning room (20), providing preferred climatological conditions;
at least one external unit (30) providing necessary cooling for the air-conditioning room (20);
at least one internal unit (40) providing heating, cooling, humidification and dehumidification within the air-conditioning room (20);
at least one cab sensor (50) measuring a temperature and humidification value of the air-conditioning room (20);
at least one humidifier (60) providing a necessary humidification for the air-conditioning room (20);
at least one heater (70) providing a necessary heat for the air-conditioning room (20),
at least one illuminator (80) providing a necessary illumination for the air-conditioning room (20);
at least one dosing pump providing a proportional flow of cooling liquid required for the cooling of the air-conditioning room (20) and a three-way or four-way mixer valve (90) having a plurality of outlets; and
at least one control unit (100) controlling the temperature and humidification values of the air conditioning room (20) and providing a preferred temperature and humidification value and cold accumulation for the air conditioning room (20).

20. A climate simulation system (10) with cold accumulation according to claim 19, wherein the at least one external unit includes at least one compressor (31), a condenser (32), a condenser fan (33), an evaporator (34), a refrigerating liquid accumulator tank (35), a refrigerating liquid (36) and temperature probe (37).

21. A climate simulation system (10) with cold accumulation according to claim 19, further comprising at least one evaporator (34) disposed in a refrigerating liquid accumulator tank (35) and providing cooling of a refrigerating liquid (36).

22. A climate simulation system (10) with cold accumulation according to claim 20, further comprising at least one evaporator (34) disposed in the refrigerating liquid accumulator tank (35) and providing cooling of the refrigerating liquid (36).

23. A climate simulation system (10) with cold accumulation according to claim 20, further comprising at least one accumulator recirculation pump (93) placed at an output of the refrigerating liquid accumulator tank (35) and providing the refrigerating liquid (36) to be depressed from the refrigerating liquid accumulator tank to a battery (41).

24. A climate simulation system (10) with cold accumulation according to claim 19, wherein the internal unit (40), the cab sensor (50), the humidifier (60), the heater (70) and the illuminator (80) are contained within the at least one air-conditioning room (20).

25. A climate simulation system (10) with cold accumulation according to claim 23, wherein the mixer valve (90) is a four-way mixer valve comprising at least one accumulator outlet (91), at least one accumulator rotation (91.1), at least one battery inlet (92) and at least one battery outlet (92.1).

26. A climate simulation system (10) with cold accumulation according to claim 19, wherein the at least one control unit (100) providing the temperature and humidification values of the air-conditioning room to be selected for day or night, and the values entered or selected on an hourly setting.

27. A climate simulation system (10) with cold accumulation according to claim 19, further comprising a refrigerating liquid (36) placed in a refrigerating liquid accumulator tank (35) and providing the cooling of the air-conditioning room.

28. A climate simulation system (10) with cold accumulation according to claim 27, wherein the at least one control unit calculates the necessary temperature value of the refrigerating liquid according to the preferred temperature of the air-conditioning room (20).

29. A climate simulation system (10) with cold accumulation according to claim 19, having at least one four-way mixer valve (90) wherein a clearance ratio of valve inlets and valve outlets (91, 92) are proportionally adjusted.

30. A climate simulation system (10) with cold accumulation according to claim 19, wherein the at least one control unit (100) calculates a clearance ratio of valve (90) inlets and valve outlets (91, 91.1, 92, 92.1) according to a deviation in the air-conditioning room (20) temperature and enabling the valve (90) to meet the clearance ratio.

31. A climate simulation system (10) with cold accumulation according to claim 19, wherein one of the plurality of outlets of the mixer valve (90) is directly connected to a battery outlet (92.1) for a battery (41) or to a refrigerating liquid accumulator tank (35)

32. A climate simulation system (10) with cold accumulation according to claim 23, further comprising at least one battery circulation pump (93.1) placed in one of the plurality of outlets of the four-way mixer valve (90) and providing a refrigerating liquid (36) in the battery to be depressed into the liquid accumulator tank (35).

33. A climate simulation system (10) with cold accumulation according to claim 19, wherein the mixer valve (90) is a three-way mixer valve and comprises a gap ratio proportionally adjusted.

34. A climate simulation system (10) with cold accumulation according to claim 23, further comprising at least one battery circulation pump (93.1) providing a circulation within the battery (41) and the cooling of the battery homogenously.

35. A climate simulation system (10) with cold accumulation according to claim 20, wherein at least one compressor (31) providing a constant cooling of the liquid (36) within the refrigerating liquid accumulator tank (35).

36. A climate simulation system (10) with cold accumulation according to claim 23, wherein the at least one control unit (100) controlling the temperature of the air-conditioning room (20) proportionally according to a temperature of the refrigerating liquid (36) in the cab sensor (50) and/or the battery.

37. A climate simulation system (10) with cold accumulation according to claim 23, further comprising at least one temperature sensor (41.1) measuring a temperature of the refrigerating liquid (36) within the battery (41).
